(19) United States
(12) Patent Application Publication
(10) Pub. No.: US 2026/0135715 A1
(43) Pub. Date: May 14, 2026

(54) ELECTRONIC SIGNATURE SYSTEM, INFORMATION PROCESSING DEVICE, AND INFORMATION PROCESSING METHOD

(71) Applicant: Panasonic Intellectual Property Management Co., Ltd., Osaka (JP)

(72) Inventors: Cong LIU, Osaka (JP); Akira MARUKO, Osaka (JP); Yuji UNAGAMI, Osaka (JP); Naohisa NISHIDA, Kanagawa (JP)

(73) Assignee: Panasonic Intellectual Property Management Co., Ltd., Osaka (JP)

(21) Appl. No.: 19/442,554

(22) Filed: Jan. 7, 2026

Related U.S. Application Data
(63) Continuation of application No. PCT/JP2024/014751, filed on Apr. 11, 2024.

(30) Foreign Application Priority Data
Jul. 12, 2023 (JP) 2023-114778

(51) Int. Cl. H04L 9/32; H04L 9/08

(52) U.S. Cl. CPC H04L 9/3247; H04L 9/0816

(57) ABSTRACT

An electronic signature system includes an information processing device, an information processing device which is higher in processing speed than the information processing device, the information processing device acquires a message, generates a digest from the message, and transmits the digest to the information processing device, the information processing device receives the digest from the information processing device, generates an electronic signature from the digest, and transmits the electronic signature to the information processing device, and the information processing device receives the electronic signature from the information processing device, adds the electronic signature to the message, and outputs the message with the electronic signature added.

### CROSS REFERENCE TO RELATED APPLICATIONS

This is a continuation application of PCT International Application No. PCT/JP2024/014751 filed on Apr. 11, 2024, designating the United States of America, which is based on and claims priority of Japanese Patent Application No. 2023-114778 filed on Jul. 12, 2023. The entire disclosures of the above-identified applications, including the specifications, drawings and claims are incorporated herein by reference in their entirety.

### FIELD

The present disclosure relates to an electronic signature system and the like which add an electronic signature to a message.

### BACKGROUND

Patent Literature 1 proposes a system which delegates signature generation in a content centric network (CCN). In the system, a content generation device generates a content object, and delegates digital signature generation to a content issuance device. The content issuance device monitors the content object generated by the content generation device, and extracts the content object. Then, the content issuance device generates a manifest for the content object, and generates a digital signature for the manifest.

### CITATION LIST

### Patent Literature

PTL 1: Japanese Unexamined Patent Application Publication No. 2016-119660

### SUMMARY

### Technical Problem

However, in the system disclosed in PTL 1, the content object generated by the content generation device is extracted by the content issuance device. Hence, the risk of the content object being tampered with is increased, and the amount of communication involved in the communication of the content object is also increased.

In view of the above, the present disclosure provides an electronic signature system and the like which can add an electronic signature with low delay to a message acquired by an information processing device having a low processing speed while suppressing the risk of tampering and spoofing and the amount of communication.

### Solution to Problem

An electronic signature system according to an aspect of the present disclosure includes: a first information processing device; and a second information processing device that is higher in processing speed than the first information processing device, the first information processing device: acquires a message; generates a digest from the message; and transmits the digest to the second information processing device, the second information processing device: receives the digest from the first information processing device; generates an electronic signature from the digest; and transmits the electronic signature to the first information processing device, and the first information processing device: receives the electronic signature from the second information processing device; adds the electronic signature to the message; and outputs the message with the electronic signature added.

These general or specific aspects may be realized by a system, a device, a method, an integrated circuit, a computer program, or a non-transitory computer-readable recording medium such as a CD-ROM, or may be realized by any combination of a system, a device, a method, an integrated circuit, a computer program, and a recording medium.

### Advantageous Effects

In an electronic signature system and the like according to an aspect of the present disclosure, it is possible to add an electronic signature with low delay to a message acquired by an information processing device having a low processing speed while suppressing the risk of tampering and spoofing and the amount of communication.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram showing an example of the configuration of a communication system in a reference example.

FIG. 2 is a conceptual diagram showing signature calculation in SPHINCS+.

FIG. 3 is a conceptual diagram showing a pseudocode for the signature calculation in SPHINCS+.

FIG. 4 is a comparison diagram showing times for the signature calculation in SPHINCS+.

FIG. 5 is a block diagram showing a first configuration example of an electronic signature system in an embodiment.

FIG. 6 is a block diagram showing a second configuration example of the electronic signature system in the embodiment.

FIG. 7 is a block diagram showing a third configuration example of the electronic signature system in the embodiment.

FIG. 8 is a block diagram showing a fourth configuration example of the electronic signature system in the embodiment.

FIG. 9 is a conceptual diagram showing a protected region in the embodiment.

FIG. 10 is a sequence diagram showing a first operation example of the electronic signature system in the embodiment.

FIG. 11 is a sequence diagram showing a second operation example of the electronic signature system in the embodiment.

FIG. 12 is a sequence diagram showing a third operation example of the electronic signature system in the embodiment.

FIG. 13 is a sequence diagram showing a fourth operation example of the electronic signature system in the embodiment.

FIG. 14 is a block diagram showing a typical configuration example of the electronic signature system in the embodiment.

FIG. 15 is a sequence diagram showing a typical operation example of the electronic signature system in the embodiment.

### DESCRIPTION OF EMBODIMENT

In recent years, communication networks have developed, and various messages are transmitted via the communication networks. In this way, it is possible to collect various messages.

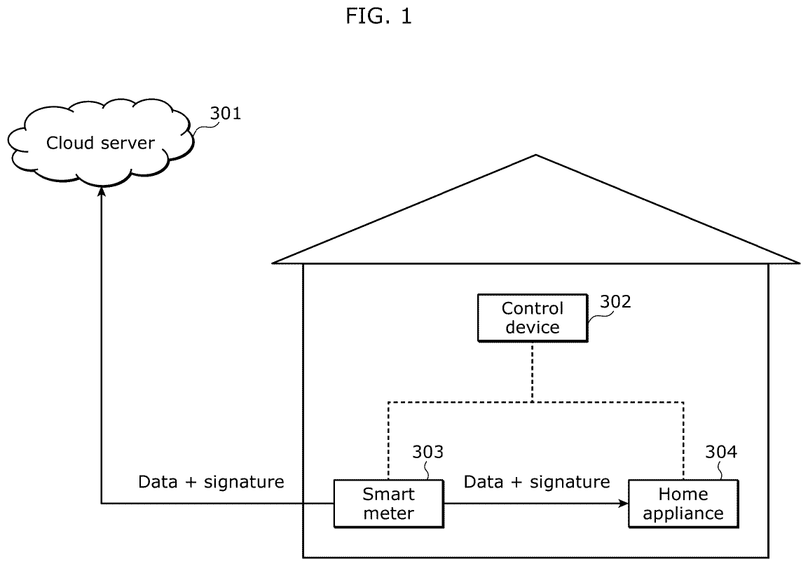

FIG. 1 is a block diagram showing an example of the configuration of a communication system in a reference example. The communication system shown in FIG. 1 includes cloud server 301, control device 302, smart meter 303, home appliance 304, and the like.

Cloud server 301 is a server in a power management company, collects data from smart meter 303 and the like, and manages the amount of power used. Control device 302 controls the operations of smart meter 303, home appliance 304, and the like.

Smart meter 303 is a battery-powered meter which can communicate with cloud server 301 and home appliance 304. Specifically, smart meter 303 periodically measures data of the amount of power used, and transmits the measured data to cloud server 301 and home appliance 304. Home appliance 304 is a home computer, acquires data from smart meter 303 and the like, and presents the amount of power used.

In the communication system described above, smart meter 303 adds an electronic signature to data in order to prove the authenticity of the data and its source. The electronic signature may be referred as the signature or the digital signature. In particular, an electronic signature which uses public key cryptography may be referred as the digital signature. In the present disclosure, the electronic signature, the signature, and the digital signature can be used interchangeably. Cloud server 301 and home appliance 304 can confirm the authenticity of the data and its source by verifying the electronic signature.

Although here, as an example, the data of the amount of power used is transmitted, various messages can be transmitted via the communication network. Then, an electronic signature can be added to each of the messages.

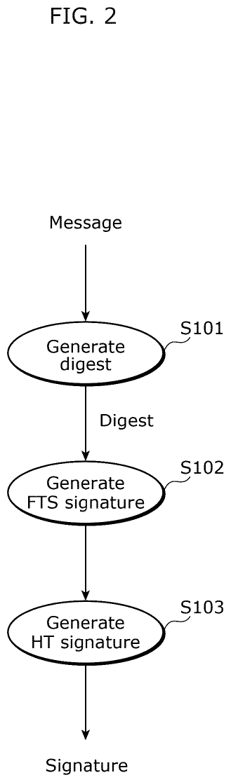

FIG. 2 is a conceptual diagram showing signature calculation in SPHINCS+. SPHINCS+ is a stateless hash-based signature scheme, and is a next-generation electronic signature scheme for post-quantum cryptography (PQC). SPHINCS+ is an evolved version of a signature scheme called stateless practical hash-based incredibly nice cryptographic signatures (SPHINCS).

SPHINCS+ is characterized in that SPHINCS+ does not utilize the difficulty of mathematical problems such as a lattice problem.

As shown in FIG. 2, in SPHINCS+, a digest is first generated from a message (S101). Specifically, a hash value obtained by inputting the message into a hash function is calculated as the digest, and thus the hash value is generated as the digest. For example, a standard hash function such as SHAKE256, SHA-256, or Haraka is used.

Then, a signature is generated from the digest according to few-time signature (FTS) (S102). The signature generated according to FTS is called an FTS signature. In other words, the FTS signature is calculated from the digest, and thus the FTS signature is generated from the digest.

There are various types of FTS, such as hash to obtain random subset (HORS), hash to obtain random subset tree (HORST), and forest of random subsets (FORS). In SPHINCS+, FORS is used.

Furthermore, a signature is generated from the public key of FTS according to hypertree (HT) (S103). The signature generated according to HT is called an HT signature. In other words, the HT signature is calculated from the public key of the FTS signature, and thus the HT signature is generated from the digest.

Then, the combination of the FTS signature and the HT signature is output as the signature of SPHINCS+.

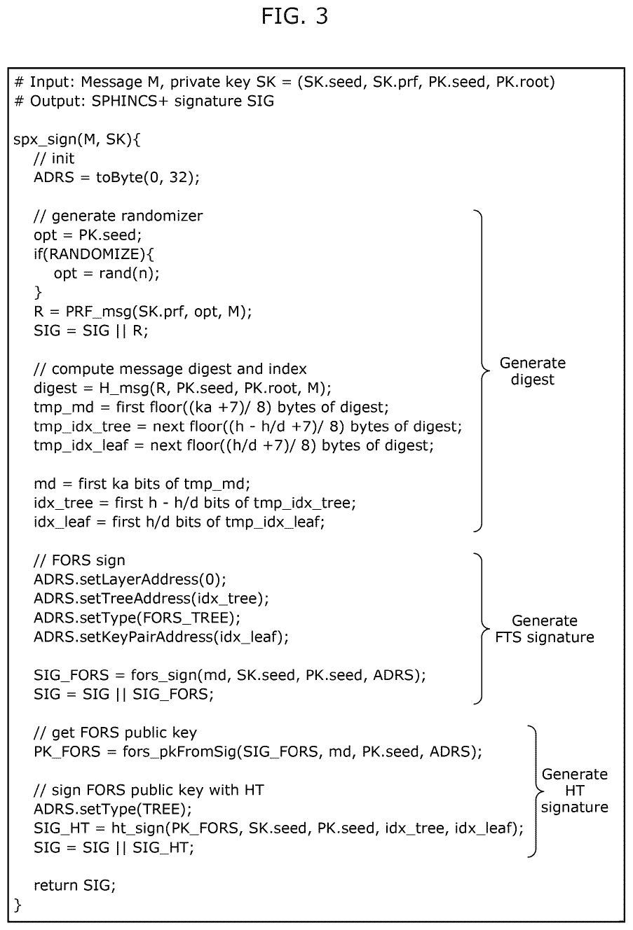

FIG. 3 is a conceptual diagram showing a pseudocode for the signature calculation in SPHINCS+. As shown in FIG. 3, the digest is generated from the message. Then, the FTS signature is generated from the digest. Then, the HT signature is generated from the public key of the FTS signature. Then, the combination of the FTS signature and the HT signature is output as the signature of SPHINCS+.

For example, SPHINCS+ which is the signature scheme as described above may be used in the communication system shown in FIG. 1 and the like. In this way, the reliability of the message is enhanced.

However, the signature calculation in SPHINCS+ takes time. Specifically, the signature calculation in SPHINCS+ takes more time than signature calculation corresponding to a conventional encryption scheme, and also takes more than signature calculation corresponding to another encryption scheme in PQC such as dilithium.

In an IoT device such as smart meter 303 shown in FIG. 1, the circuit scale is small, and the processing speed is slow. In a battery-powered IoT device such as smart meter 303 shown in FIG. 1, a time-consuming calculation reduces the battery life.

For example, in the signature calculation in SPHINCS+, the hash function is used several hundreds of thousands to several millions of times. Hence, a hardware accelerator for the hash function alone may be installed in the IoT device such as smart meter 303 shown in FIG. 1. However, an input to the hash function is so short as to be 200 bytes or less per input, and thus the installation of the hardware accelerator is not effective.

In particular, in the IoT device, it takes time to generate the FTS signature and the HT signature. For example, even in the IoT device, the time required to generate the digest is usually less than or equal to 1 ms. However, in the case of the IoT device, the generation of the FTS signature and the HT signature takes several tens of seconds or more. On the other hand, in the case of a high specification device such as a general-purpose computer system, the time required to generate the FTS signature and the HT signature is about several tens to several hundreds of milliseconds.

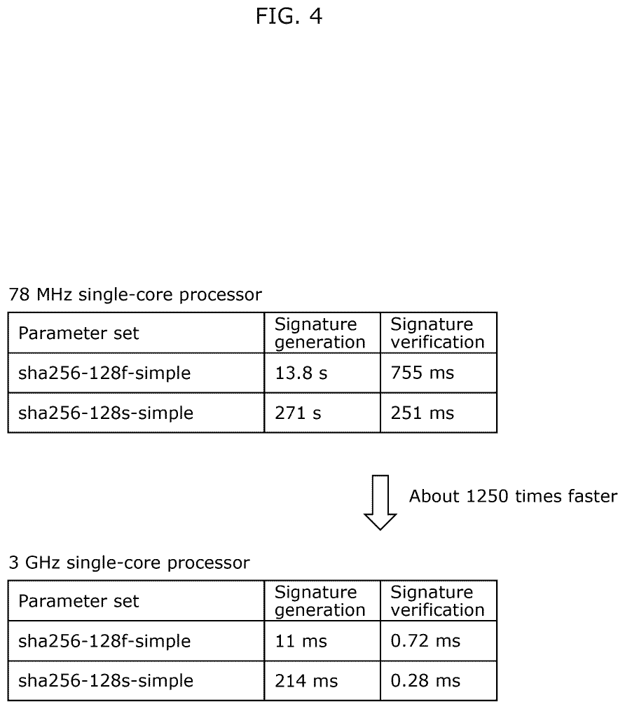

FIG. 4 is a comparison diagram showing times for signature generation in SPHINCS+. Specifically, an upper table in FIG. 4 shows times required for signature generation and signature verification executed by a 78 MHz single-core processor. The 78 MHz single-core processor corresponds to a processor installed in the IoT device. A lower table in FIG. 4 shows times required for signature generation and signature verification executed by a 3 GHz single-core processor. The 3 GHZ single-core processor corresponds to a processor installed in the high specification device such as a general-purpose computer system.

In FIG. 4, parameter sets are parameter sets for the signature generation. FIG. 4 shows the time required for each of the signature generation and the signature verification in two types of parameter sets, that is, sha256-128f-simple and sha256-128s-simple. For example, in the 78 MHz processor, the time required for the signature generation in sha256-128f-simple is 13.8 s. On the other hand, in the 3 GHz processor, the time required for the signature generation in sha256-128f-simple is 11 ms.

In other words, the 3 GHz processor can execute the signature generation about 1250 times faster than the 78 MHz processor. By contrast, the 78 MHz processor takes about 1250 times longer to execute the signature generation than the 3 GHz processor. Furthermore, in the case of another unillustrated parameter set (sha256-256s-robust), in the 78 MHz processor, the time required for the signature generation is 18 minutes. On the other hand, the time required for the signature verification in each case is within one second.

As described above, in the IOT device, the signature calculation takes a long time. Hence, it is difficult to transmit the message in a short time. The life of a battery used in the IoT device may be reduced. As shown in the examples of the IoT device and SPHINCS+, in an information processing device having a low processing speed, it is not easy to add an electronic signature to a message.

In the system disclosed in PTL 1, the content generation device generates the content object, and delegates the digital signature generation to the content issuance device. The content issuance device monitors the content object generated by the content generation device, and extracts the content object. Then, the content issuance device generates the manifest for the content object, and generates the digital signature for the manifest.

However, in the system disclosed in PTL 1, the content object generated by the content generation device is extracted by the content issuance device. Hence, the risk of the content object being tampered with is increased, and the amount of communication involved in the communication of the content object is also increased.

Hence, an electronic signature system in example 1 according to an aspect of the present disclosure includes: a first information processing device; and a second information processing device that is higher in processing speed than the first information processing device, the first information processing device: acquires a message; generates a digest from the message; and transmits the digest to the second information processing device, the second information processing device: receives the digest from the first information processing device; generates an electronic signature from the digest; and transmits the electronic signature to the first information processing device, and the first information processing device: receives the electronic signature from the second information processing device; adds the electronic signature to the message; and outputs the message with the electronic signature added.

In this way, it is possible to generate the digest using the first information processing device which is lower in processing speed, and to generate the electronic signature using the second information processing device which is higher in processing speed. Hence, it is possible to suppress the transmission of the message itself. Therefore, it is possible to add the electronic signature with low delay to the message acquired by the information processing device which is lower in processing speed while suppressing the risk of tampering and spoofing and the amount of communication.

An electronic signature system in example 2 according to an aspect of the present disclosure may be the electronic signature system in example 1 where the first information processing device transmits, to the second information processing device, a parameter corresponding to a private key for generating the electronic signature, and the second information processing device: receives the parameter from the first information processing device; and uses the parameter to generate the electronic signature from the digest.

In this way, it is possible to utilize, for the generation of the electronic signature, the parameter transmitted from the first information processing device and received by the second information processing device. Hence, instead of the first information processing device, in the second information processing device, it is possible to correctly generate the electronic signature.

An electronic signature system in example 3 according to an aspect of the present disclosure may be the electronic signature system in example 2 where the first information processing device transmits the parameter to the second information processing device together with the digest, and the second information processing device receives the parameter from the first information processing device together with the digest.

In this way, it is possible to smoothly generate the electronic signature from the digest using the parameter which is transmitted and received together with the digest.

An electronic signature system in example 4 according to an aspect of the present disclosure may be the electronic signature system in example 2 where the first information processing device transmits, before transmitting the digest, the parameter to the second information processing device separately from the digest, and the second information processing device receives, before receiving the digest, the parameter from the first information processing device separately from the digest.

In this way, it is possible to generate the electronic signature from the digest using the parameter which is transmitted and received beforehand. Hence, it is possible to suppress the leakage of the parameter corresponding to the private key.

An electronic signature system in example 5 according to an aspect of the present disclosure may be the electronic signature system in any one of examples 1 to 4 where the first information processing device: verifies the electronic signature after receiving the electronic signature from the second information processing device, and adds the electronic signature to the message upon successful verification of the electronic signature.

In this way, it is possible to add the electronic signature to the message after confirming the authenticity of the electronic signature. Hence, it is possible to further suppress the risk of tampering, spoofing, and the like.

An electronic signature system in example 6 according to an aspect of the present disclosure may be the electronic signature system in any one of examples 1 to 5 where the electronic signature includes a first electronic signature and a second electronic signature, the second information processing device: generates the first electronic signature from the digest; generates the second electronic signature from a public key of the first electronic signature; and transmits the first electronic signature and the second electronic signature to the first information processing device, and the first information processing device: receives the first electronic signature and the second electronic signature from the second information processing device; adds the first electronic signature and the second electronic signature to the message; and outputs the message with the first electronic signature and the second electronic signature added.

In this way, it is possible to generate the two electronic signatures using the second information processing device which is higher in processing speed. Hence, it is possible to suppress a processing delay as compared with a case where the first information processing device which is lower in processing speed generates the two electronic signatures.

An electronic signature system in example 7 according to an aspect of the present disclosure may be the electronic signature system in example 6 where the second information processing device: transmits the first electronic signature to the first information processing device after generating the first electronic signature and before generating the second electronic signature; and transmits the second electronic signature to the first information processing device after generating the second electronic signature, and the first information processing device: starts to verify the first electronic signature after receiving the first electronic signature and before receiving the second electronic signature; starts to verify the second electronic signature after receiving the second electronic signature; and adds the first electronic signature and the second electronic signature to the message upon successful verification of the first electronic signature and the second electronic signature.

In this way, it is possible to add the first electronic signature and the second electronic signature to the message after confirming the authenticity of the first electronic signature and the second electronic signature. Hence, it is possible to further suppress the risk of tampering, spoofing, and the like. It is also possible to start to verify the first electronic signature at an early stage. Therefore, it is possible to suppress a processing delay.

An electronic signature system in example 8 according to an aspect of the present disclosure may be the electronic signature system in example 6 or 7 where the electronic signature complies with SPHINCS+, the first electronic signature complies with few-times signature (FTS), and the second electronic signature complies with hypertree (HT).

In this way, it is possible to add the highly reliable electronic signatures to the messages according to SPHINCS+, FTS and HT.

An electronic signature system in example 9 according to an aspect of the present disclosure may be the electronic signature system in any one of examples 1 to 8 where the second information processing device generates the electronic signature in a protected region where storage and transmission are performed in an encrypted state.

In this way, in the second information processing device, it is possible to further suppress the risk of tampering and spoofing.

An electronic signature system in example 10 according to an aspect of the present disclosure may be the electronic signature system in any one of examples 1 to 9 where when a condition for generating the electronic signature in the first information processing device is satisfied, the first information processing device generates the electronic signature from the digest without transmitting the digest to the second information processing device.

In this way, it is possible to adaptively generate the electronic signature in the first information processing device or the second information processing device according to the condition. Hence, it is possible to efficiently distribute the processing.

An information processing device in example 11 according to an aspect of the present disclosure includes: an acquirer that acquires a message; a digest generator that generates a digest from the message; a communicator that: transmits the digest to a high-speed information processing device that is higher in processing speed than the information processing device; and receives an electronic signature from the high-speed information processing device; and an outputter that adds the electronic signature to the message, and outputs the message with the electronic signature added.

In this way, it is possible to generate the digest using the information processing device which is lower in processing speed, and to generate the electronic signature using the high-speed information processing device which is higher in processing speed. Hence, it is possible to suppress the transmission of the message itself. Therefore, it is possible to add the electronic signature with low delay to the message acquired by the information processing device which is lower in processing speed while suppressing the risk of tampering and spoofing and the amount of communication.

An information processing device in example 12 according to an aspect of the present disclosure includes: a communicator that receives a digest from a low-speed information processing device that is lower in processing speed than the information processing device; and a signature generator that generates an electronic signature from the digest, and the communicator transmits the electronic signature to the low-speed information processing device.

In this way, it is possible to cause the low-speed information processing device which is lower in processing speed to generate the digest, and to generate the electronic signature using the information processing device which is higher in processing speed. Hence, it is possible to suppress the transmission of the message itself. Therefore, it is possible to add the electronic signature with low delay to the message acquired by the low-speed information processing device which is lower in processing speed while suppressing the risk of tampering and spoofing and the amount of communication.

An information processing method in example 13 according to an aspect of the present disclosure is an information processing method executed by an information processing device, and the information processing method includes: acquiring a message; generating a digest from the message; transmitting the digest to a high-speed information processing device that is higher in processing speed than the information processing device; receiving an electronic signature from the high-speed information processing device; adding the electronic signature to the message; and outputting the message with the electronic signature added.

In this way, it is possible to generate the digest using the information processing device which is lower in processing speed, and to cause the high-speed information processing device which is higher in processing speed to generate the electronic signature. Hence, it is possible to suppress the transmission of the message itself. Therefore, it is possible to add the electronic signature with low delay to the message acquired by the information processing device which is lower in processing speed while suppressing the risk of tampering and spoofing and the amount of communication.

An information processing method in example 14 according to an aspect of the present disclosure is an information processing method executed by an information processing device, and the information processing method includes: receiving a digest from a low-speed information processing device that is lower in processing speed than the information processing device; generating an electronic signature from the digest; and transmitting the electronic signature to the low-speed information processing device.

In this way, it is possible to cause the low-speed information processing device which is lower in processing speed to generate the digest, and to generate the electronic signature using the information processing device which is higher in processing speed. Hence, it is possible to suppress the transmission of the message itself. Therefore, it is possible to add the electronic signature with low delay to the message acquired by the low-speed information processing device which is lower in processing speed while suppressing the risk of tampering and spoofing and the amount of communication.

A program in example 15 according to an aspect of the present disclosure is a program for causing the information processing device to execute the information processing method in example 13 or 14.

In this way, using the program, it is possible to cause the information processing device to accurately execute the information processing method.

Furthermore, these general or specific aspects may be realized by a system, a device, a method, an integrated circuit, a computer program, or a non-transitory computer-readable recording medium such as a CD-ROM, or may be realized by any combination of a system, a device, a method, an integrated circuit, a computer program, and a recording medium.

An embodiment will be described below with reference to drawings. The embodiment described below indicates a general or specific example. Numerical values, shapes, materials, constituent elements, the arrangement and connection of the constituent elements, steps, the order of the steps, and the like shown in the following embodiment are examples, and are not intended to limit the present disclosure.

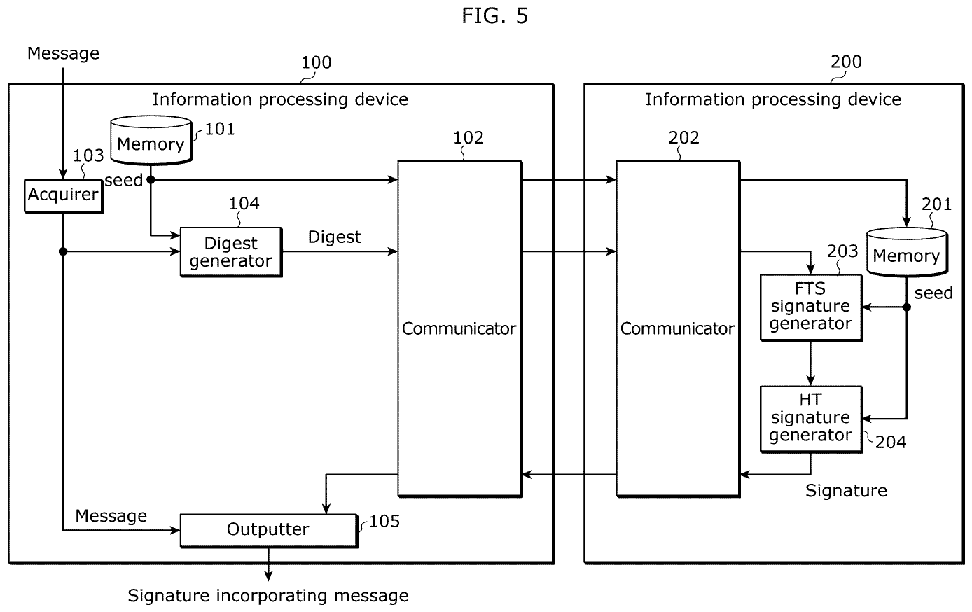

FIG. 5 is a block diagram showing a first configuration example of an electronic signature system in the embodiment. The electronic signature system shown in FIG. 5 includes information processing device 100 and information processing device 200, and adds an electronic signature to a message according to SPHINCS+.

For example, information processing device 100 is an IoT device such as smart meter 303 shown in FIG. 1, and information processing device 200 is a high specification device such as a general-purpose computer system. Control device 302 shown in FIG. 1 may be a high specification device corresponding to information processing device 200. The processing speed of information processing device 100 is lower than that of information processing device 200. In other words, the processing speed of information processing device 200 is higher than that of information processing device 100.

Information processing device 100 includes memory 101, communicator 102, acquirer 103, digest generator 104, and outputter 105.

Memory 101 is, for example, an information storage medium, and stores information. Memory 101 may be a volatile memory, or may be a nonvolatile memory. Specifically, memory 101 stores seeds which are parameters corresponding to a private key and a public key for electronic signature. Here, examples of the seed include a PK. seed (public seed) and a SK. seed (private seed). Using the seeds, a public key and a private key related to the FTS signature, and a public key and a private key related to the HT signature are generated.

For the generation of the digest, the generation of the signature, and the verification of the signature, the seeds are used. Specifically, for the generation of the digest and the verification of the signature, the PK. seed is used. For the generation of the signature, both the PK. seed and the SK. seed are used.

Communicator 102 is, for example, a communication processing circuit, and executes information communication. Communicator 102 may execute information communication with information processing device 200 by secure communication. Communicator 102 may include a transmitter which transmits information and a receiver which receives information. Specifically, communicator 102 transmits the seed stored in memory 101 and the digest generated by digest generator 104 to information processing device 200. Communicator 102 receives, from information processing device 200, the FTS signature and the HT signature generated by information processing device 200.

Acquirer 103 is, for example, an information processing circuit, and acquires information. Specifically, acquirer 103 acquires the message to which the signature has not been added. Acquirer 103 may acquire the message from the outside of information processing device 100, or may acquire the message from the interior of information processing device 100.

For example, acquirer 103 may acquire the message by generating the message or by calculation. Acquirer 103 may be a sensor, a measurer, or the like, and may acquire sensed information or measured information as the message.

Digest generator 104 is, for example, an information processing circuit, and generates the digest. Specifically, digest generator 104 generates the digest from the message acquired by acquirer 103.

More specifically, digest generator 104 calculates, as the digest, a hash value obtained by inputting the message into a hash function, and thus the hash value is generated as the digest. For example, digest generator 104 uses a standard hash function such as SHAKE256, SHA-256, or Haraka to generate the digest from the message.

For the generation of the digest, the PK. seed is used. Specifically, digest generator 104 generates, as the digest, the hash value obtained by connecting the PK. seed, the message and the like, and inputting them into the hash function.

Outputter 105 is, for example, an output processing circuit, and outputs information. Specifically, outputter 105 outputs a signature incorporating message with the signature added. For example, outputter 105 adds, as the signature of SPHINCS+, the combination of the FTS signature and the HT signature received by communicator 102 to the message acquired by acquirer 103, and outputs the signature incorporating message.

More specifically, the signature of SPHINCS+ is obtained by coupling an intermediate hash value calculated as R when the digest is generated, the FTS signature, and the HT signature. Information processing device 100 may include a coupler which couples the FTS signature, the HT signature, and the like. Outputter 105 may include such a coupler.

Adding the signature to the message corresponds to attaching the signature to the message, coupling the signature to the message, or assigning the signature to the message. Information processing device 100 may include, in addition to outputter 105, a signature adder which adds the signature to the message, or outputter 105 may include such a signature adder.

For example, outputter 105 may output the signature incorporating message by transmitting the signature incorporating message to cloud server 301 or home appliance 304 shown in FIG. 1. Outputter 105 may be integrated with communicator 102.

Information processing device 200 includes memory 201, communicator 202, FTS signature generator 203, and HT signature generator 204.

Memory 201 is, for example, an information storage medium, and stores information. Memory 201 may be a volatile memory, or may be a nonvolatile memory. Specifically, memory 201 stores the seed received by communicator 202.

Communicator 202 is, for example, a communication processing circuit, and executes information communication. Communicator 202 may execute information communication with information processing device 100 by secure communication. Communicator 202 may include a transmitter which transmits information and a receiver which receives information.

Specifically, communicator 202 receives, from information processing device 100, the seed stored in information processing device 100 and the digest generated by information processing device 100. Communicator 202 transmits, to information processing device 100, the FTS signature generated by FTS signature generator 203 and the signature generated by HT signature generator 204.

FTS signature generator 203 is, for example, an information processing circuit, and generates the FTS signature. Specifically, FTS signature generator 203 generates the FTS signature from the digest received by communicator 202. The seed stored in memory 201 is used for the generation of the FTS signature.

More specifically, the digest is expressed in, for example, 256 bits. Of the 256 bits, 192 bits on the left are expressed as md, and 64 bits on the right are expressed as index. FTS signature generator 203 generates the FTS signature from the md, the SK. seed, the PK. seed, and the index. Conceptually, a private key and a public key for the FTS signature are determined by the seed and the index. Then, the FTS signature is generated from the md according to the private key and the public key.

HT signature generator 204 is, for example, an information processing circuit, and generates the HT signature. Specifically, HT signature generator 204 generates the HT signature from the public key of the FTS signature generated by FTS signature generator 203. The seed stored in memory 201 is used for the generation of the HT signature.

More specifically, HT signature generator 204 derives the public key of the FTS signature from the FTS signature, the md, the PK. seed, and the index. Then, HT signature generator 204 generates the HT signature from the public key of the FTS signature, the SK. seed, the PK. seed, and the index.

Then, the FTS signature generated by FTS signature generator 203 and the HT signature generated by HT signature generator 204 are transmitted to information processing device 100 by communicator 202.

In an example shown in FIG. 5, the electronic signature system can generate the digest using information processing device 100 which is lower in processing speed, and generate the electronic signature using information processing device 200 which is higher in processing speed. Hence, it is possible to suppress the transmission of the message itself. Therefore, it is possible to add the electronic signature with low delay to the message acquired by information processing device 100 which is lower in processing speed while suppressing the risk of tampering and spoofing and the amount of communication.

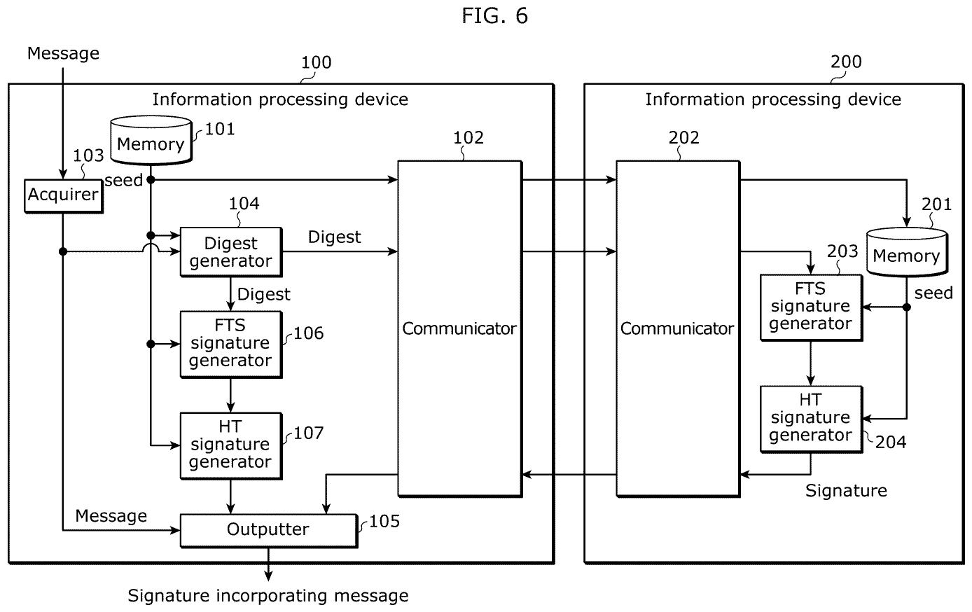

FIG. 6 is a block diagram showing a second configuration example of the electronic signature system in the embodiment. The example shown in FIG. 6 differs from the example shown in FIG. 5 in that information processing device 100 further includes FTS signature generator 106 and HT signature generator 107.

FTS signature generator 106 is, for example, an information processing circuit, and generates the FTS signature. Specifically, FTS signature generator 106 generates the FTS signature from the digest generated by digest generator 104. The seed stored in memory 101 is used for the generation of the FTS signature. An FTS signature generation method executed by FTS signature generator 106 in information processing device 100 is substantially the same as an FTS signature generation method executed by FTS signature generator 203 in information processing device 200.

HT signature generator 107 is, for example, an information processing circuit, and generates the HT signature. Specifically, HT signature generator 107 generates the HT signature from the public key of the FTS signature generated by FTS signature generator 106. The seed stored in memory 101 is used for the generation of the HT signature. An HT signature generation method executed by HT signature generator 107 in information processing device 100 is substantially the same as an HT signature generation method executed by HT signature generator 204 in information processing device 200.

In the example shown in FIG. 6, when a local generation condition which is a condition for generating the signature in information processing device 100 is satisfied, information processing device 100 generates the signature from the digest without transmitting the digest to information processing device 200.

The local generation condition is that a permissible time which is the time permitted for the generation of the signature is greater than or equal to an estimated time which is estimated as the time required for the generation of the signature in information processing device 100.

For example, the permissible time is specified for information processing device 100. Specifically, in FIG. 1, a time interval for periodically transmitting data from smart meter 303 to cloud server 301 may be specified, and thus the time interval may be specified as the permissible time.

When the permissible time is less than the estimated time, the signature may be generated by information processing device 200 without being generated by information processing device 100. On the other hand, when the permissible time is greater than or equal to the estimated time, the signature may be generated by information processing device 100. In this case, the digest does not need to be transmitted to information processing device 200.

Specifically, when the local generation condition is not satisfied, the electronic signature system in the example shown in FIG. 6 is operated as in the example shown in FIG. 5.

On the other hand, when the local generation condition is satisfied, digest generator 104 outputs the digest to FTS signature generator 106 instead of communicator 102. Then, FTS signature generator 106 generates the FTS signature from the digest. HT signature generator 107 generates the HT signature from the public key of the FTS signature. Then, outputter 105 adds, to the message, as the signature of SPHINCS+, the combination of the FTS signature and the HT signature generated by FTS signature generator 106 and HT signature generator 107 without use of information processing device 200.

Information processing device 100 may include a switch which switches between an operation for generating the signature using information processing device 100 and an operation for generating the signature using information processing device 200. The switch may switch, according to the local generation condition and the like, between the operation for generating the signature using information processing device 100 and the operation for generating the signature using information processing device 200.

In the example shown in FIG. 6, it is possible to adaptively generate the electronic signature in information processing device 100 or information processing device 200 according to the condition. Hence, it is possible to efficiently distribute the processing.

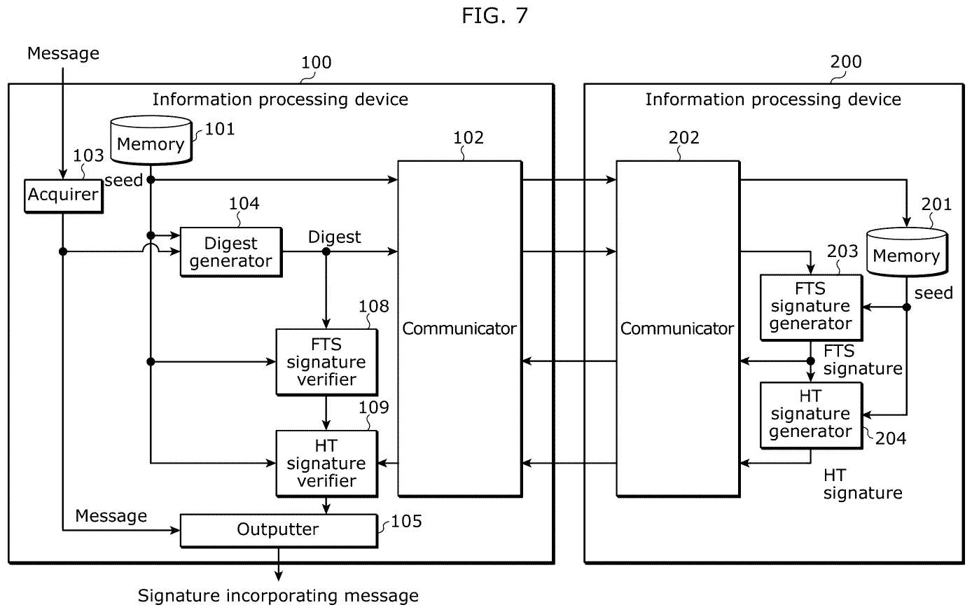

FIG. 7 is a block diagram showing a third configuration example of the electronic signature system in the embodiment. The example shown in FIG. 7 differs from the example shown in FIG. 5 in that communicator 202 in information processing device 200 transmits the FTS signature to information processing device 100 after the FTS signature is generated by FTS signature generator 203 before the HT signature is generated by HT signature generator 204. Then, communicator 102 in information processing device 100 receives the FTS signature from information processing device 200.

After the HT signature is generated by HT signature generator 204, communicator 202 in information processing device 200 transmits the HT signature to information processing device 100. Then, communicator 102 in information processing device 100 receives the HT signature from information processing device 200.

Information processing device 100 further includes FTS signature verifier 108 and HT signature verifier 109.

FTS signature verifier 108 is, for example, an information processing circuit, and verifies the FTS signature. Specifically, FTS signature verifier 108 verifies the FTS signature received by communicator 102. Here, for the verification of the FTS signature received by communicator 102, the md and the index of the digest generated by digest generator 104 and the seed stored in memory 101 are used.

More specifically, FTS signature verifier 108 derives the public key (PK_FORS′) of the FTS signature from the FTS signature, the md, the PK. seed, and the index. On the other hand, FTS signature verifier 108 derives the original public key (PK_FORS) of the FTS signature from the seed and the index. Then, FTS signature verifier 108 verifies the FTS signature according to whether the public key (PK_FORS′) of the FTS signature matches the original public key (PK_FORS) of the FTS signature.

HT signature verifier 109 is, for example, an information processing circuit, and verifies the HT signature. Specifically, HT signature verifier 109 verifies the HT signature received by communicator 102. For the verification of the HT signature received by communicator 102, the public key of the FTS signature, the index of the digest generated by digest generator 104, and the seed stored in memory 101 are used.

More specifically, HT signature verifier 109 drives the public key (PK. root′) of the HT signature from the public key of the FTS signature, the HT signature, the PK. seed, and the index. On the other hand, HT signature verifier 109 drives the original public key (PK. root) of the HT signature from the seed and the index. Then, HT signature verifier 109 verifies the HT signature according to whether the public key (PK. root′) of the HT signature matches the original public key (PK. root) of the HT signature.

Then, when FTS signature verifier 108 successfully verifies the FTS signature, and HT signature verifier 109 successfully verifies the HT signature, outputter 105 outputs a signature incorporating message. Specifically, in this case, outputter 105 adds a signature including the FTS signature and the HT signature to the message acquired by acquirer 103, and outputs the signature incorporating message.

On the other hand, when FTS signature verifier 108 fails to verify the FTS signature, or when HT signature verifier 109 fails to verify the HT signature, outputter 105 does not output the signature incorporating message. In this case, there is a possibility of tampering or spoofing. Hence, outputter 105 may output an alert. Specifically, for example, outputter 105 may transmit an alert to cloud server 301 or home appliance 304 shown in FIG. 1.

In the example shown in FIG. 7, it is possible to add the signature to the message after confirming the authenticity of the signature. Hence, it is possible to further suppress the risk of tampering, spoofing, and the like. The FTS signature is transmitted before the HT signature is generated. Therefore, it is possible to start to verify the FTS signature at an early stage. Consequently, it is possible to suppress a processing delay.

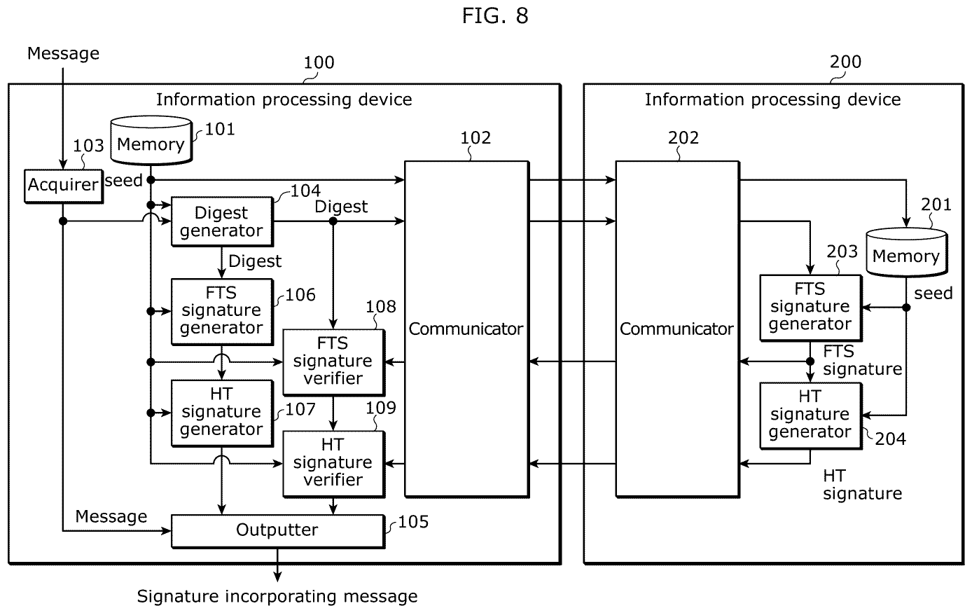

FIG. 8 is a block diagram showing a fourth configuration example of the electronic signature system in the embodiment. The example shown in FIG. 8 corresponds to the combination of the example shown in FIG. 6 and the example shown in FIG. 7. In other words, in the example shown in FIG. 8, which one of information processing device 100 and information processing device 200 generates the signature is switched depending on whether the local generation condition is satisfied. When the signature is generated by information processing device 200, the signature is verified by information processing device 100.

As in the example shown in FIG. 8, the example shown in FIG. 6 and the example shown in FIG. 7 can be combined. The example shown in FIG. 6 and the example shown in FIG. 7 are combined, and thus the effects in both the examples are obtained. The generation of the signature and the verification of the signature are based on the common method. Hence, it is possible to reduce the complexity of implementation.

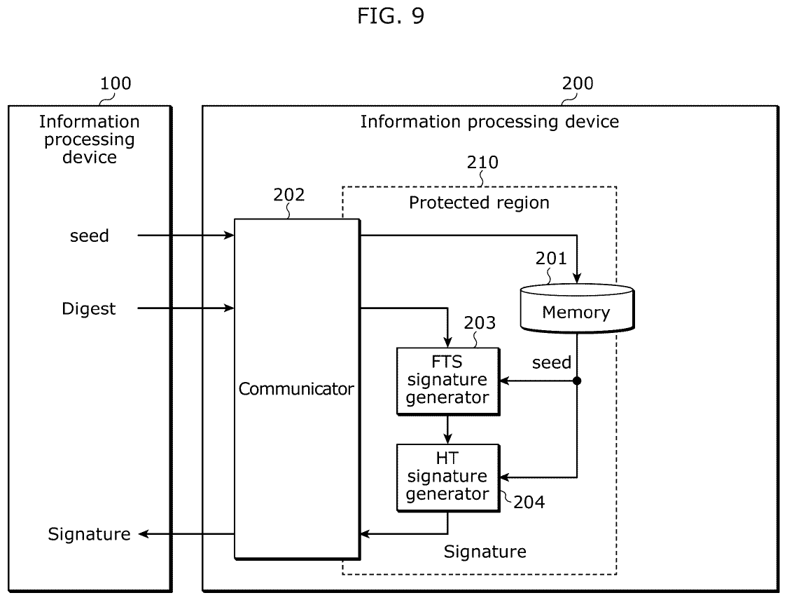

FIG. 9 is a conceptual diagram showing a protected region in the embodiment. Information processing device 200 receives the seed specific to information processing device 100. Since the processing speed of information processing device 200 is high, information processing device 200 may be utilized for another processing step. Hence, there is a risk that the seed specific to information processing device 100 may leak. In addition to the seed, there is also a risk that the signature is tampered with by another processing step.

Hence, in an example shown in FIG. 9, information processing device 200 generates the signature in protected region 210. In protected region 210, storage and transmission are performed in an encrypted state. In this way, the processing for generating the signature is protected from another processing step.

Intel (registered trademark) software guard extensions (SGX) may be used for protected region 210 as described above. Specifically, a region called an enclave is secured as protected region 210. Inside the enclave, data is placed and communicated in an encrypted state. Hence, the data is protected.

In the configuration described above, in information processing device 200, it is possible to further suppress the risk of tampering, spoofing, and the like.

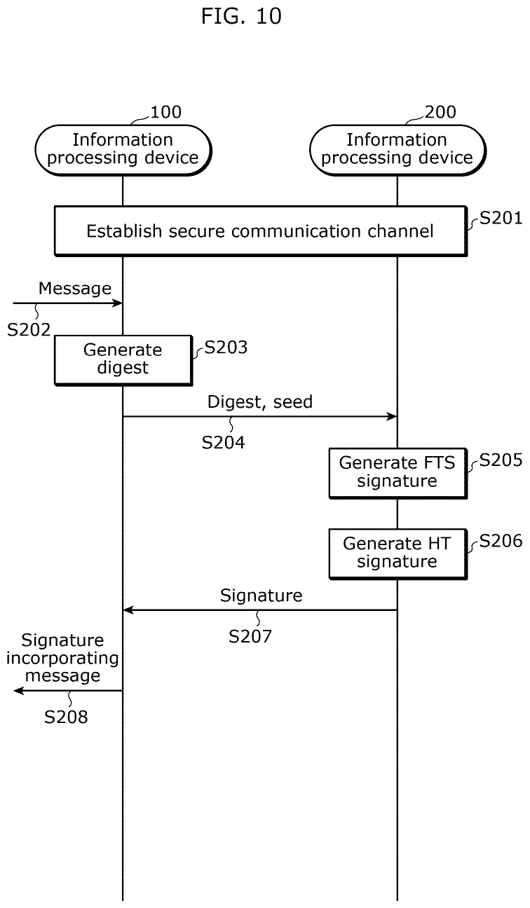

FIG. 10 is a sequence diagram showing a first operation example of the electronic signature system in the embodiment. The example shown in FIG. 10 corresponds to the operation in the example shown in FIG. 5 or an operation when the local generation condition is not satisfied in the example shown in FIG. 6.

Information processing device 100 and information processing device 200 first establish a secure communication channel (S201). In the secure communication channel, a general-purpose encryption scheme may be used.

Then, information processing device 100 receives the message (S202). Information processing device 100 may acquire the message from the outside of information processing device 100, or may acquire the message by generating the message inside information processing device 100.

Then, information processing device 100 generates the digest from the message (S203). Information processing device 100 may generate, as the digest, the hash value obtained by inputting the message into the hash function.

Then, information processing device 100 transmits the digest and the seed to information processing device 200 via the secure communication channel, and information processing device 200 receives the digest and the seed from information processing device 100 via the secure communication channel (S204).

Then, information processing device 200 uses the seed to generate the FTS signature from the digest (S205). Then, information processing device 200 uses the seed to generate the HT signature from the public key of the FTS signature (S206).

Then, information processing device 200 transmits the FTS signature and the HT signature to information processing device 100 via the secure communication channel, and information processing device 100 receives the FTS signature and the HT signature from information processing device 200 via the secure communication channel (S207).

Then, information processing device 100 adds the combination of the FTS signature and the HT signature to the message as the signature of SPHINCS+, and outputs the signature incorporating message (S208).

In the example shown in FIG. 10, the electronic signature system can generate the digest using information processing device 100 which is lower in processing speed, and generate the electronic signature using information processing device 200 which is higher in processing speed. Hence, it is possible to suppress the transmission of the message itself. Therefore, it is possible to add the electronic signature with low delay to the message acquired by information processing device 100 which is lower in processing speed while suppressing the risk of tampering and spoofing and the amount of communication.

It is possible to smoothly generate the signature from the digest using the seed which is transmitted and received together with the digest.

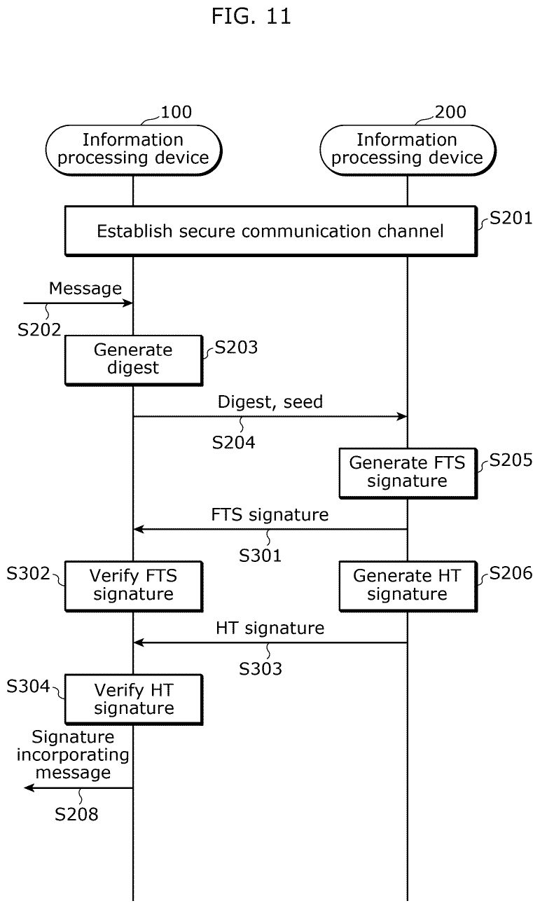

FIG. 11 is a sequence diagram showing a second operation example of the electronic signature system in the embodiment. The example shown in FIG. 11 corresponds to the operation in the example shown in FIG. 7 or an operation when the local generation condition is not satisfied in the example shown in FIG. 8.

Specifically, as in the example shown in FIG. 10, information processing device 100 and information processing device 200 first establish the secure communication channel (S201). Information processing device 100 acquires the message (S202), and generates the digest from the message (S203). Then, information processing device 100 transmits the digest and the seed to information processing device 200, and information processing device 200 receives the digest and the seed from information processing device 100 (S204).

Then, information processing device 200 uses the seed to generate the FTS signature from the digest (S205). Then, in the example shown in FIG. 11, information processing device 200 transmits the FTS signature to information processing device 100 via the secure communication channel, and information processing device 100 receives the FTS signature from information processing device 200 via the secure communication channel (S301).

Thereafter, information processing device 200 uses the seed to generate the HT signature from the public key of the FTS signature (S206). Here, information processing device 100 verifies the FTS signature in parallel with processing in which information processing device 200 generates the HT signature (S302).

Then, information processing device 200 transmits the HT signature to information processing device 100 via the secure communication channel, and information processing device 100 receives the HT signature from information processing device 200 via the secure communication channel (S303). Thereafter, information processing device 100 verifies the HT signature (S304).

When information processing device 100 successfully verifies the FTS signature, and successfully verifies the HT signature, information processing device 100 adds the combination of the FTS signature and the HT signature to the message as the signature of SPHINCS+, and outputs the signature incorporating message (S208).

In the example shown in FIG. 11, the FTS signature and the HT signature are verified, and thus it is possible to suppress the risk of tampering, spoofing, and the like. The generation of the HT signature and the verification of the FTS signature can be executed in parallel. It is assumed that each of the generation of the HT signature and the verification of the FTS signature takes about several tens to several hundreds of milliseconds. Hence, it is possible to reduce the delay in time.

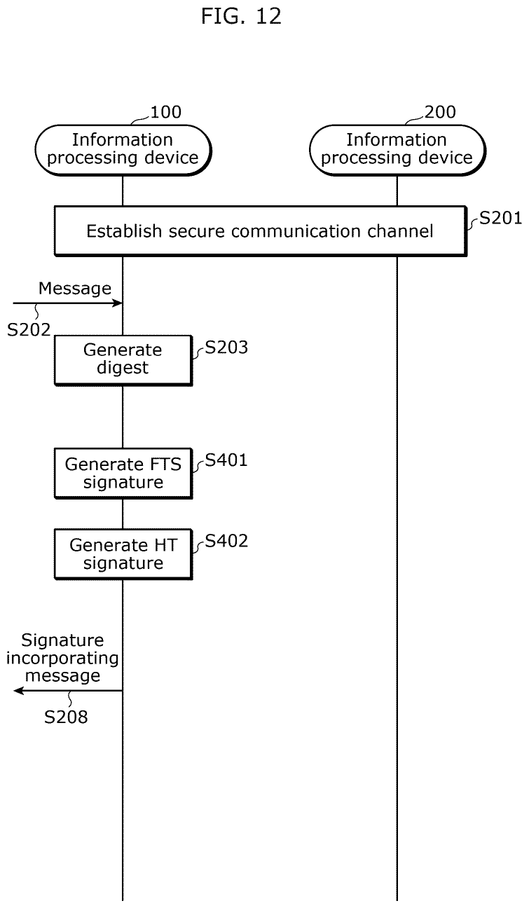

FIG. 12 is a sequence diagram showing a third operation example of the electronic signature system in the embodiment. The example shown in FIG. 12 corresponds to an operation when the local generation condition is satisfied in the example shown in FIG. 6 or an operation when the local generation condition is satisfied in the example shown in FIG. 8.

Specifically, as in the example shown in FIG. 10, information processing device 100 and information processing device 200 first establish the secure communication channel (S201). Information processing device 100 acquires the message (S202), and generates the digest from the message (S203).

Then, in the example shown in FIG. 12, information processing device 100 generates the FTS signature from the digest (S401), and generates the HT signature from the public key of the FTS signature (S402).

Then, as in the example shown in FIG. 10, information processing device 100 adds the combination of the FTS signature and the HT signature to the message as the signature of SPHINCS+, and outputs the signature incorporating message (S208).

As in the example shown in FIG. 12, when the local generation condition is satisfied, information processing device 100 may generate the FTS signature and the HT signature without use of information processing device 200. In this way, it is possible to reduce a processing load in information processing device 200.

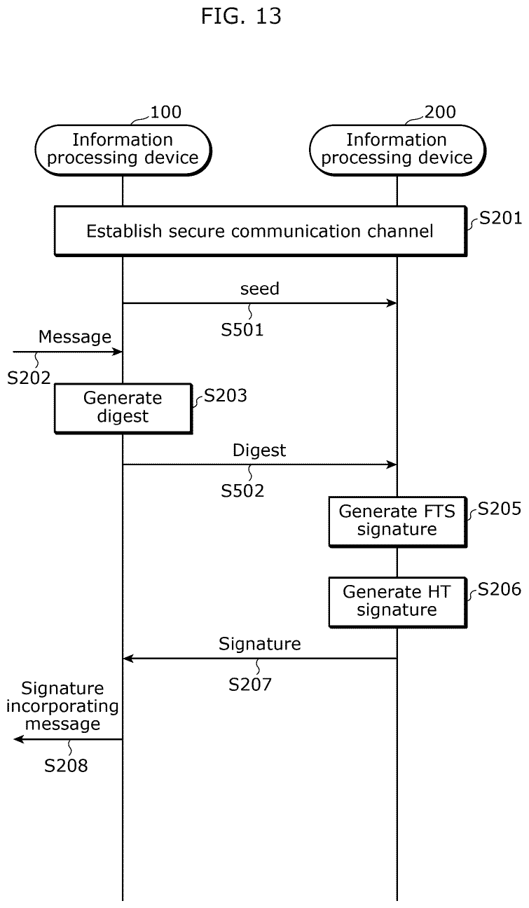

FIG. 13 is a sequence diagram showing a fourth operation example of the electronic signature system in the embodiment. Although in the example shown in FIG. 10, the seed is transmitted and received together with the digest, in the example shown in FIG. 13, the seed is transmitted and received before the digest is transmitted and received.

Specifically, as in the example shown in FIG. 10, information processing device 100 and information processing device 200 first establish the secure communication channel (S201).

Then, in the example shown in FIG. 13, information processing device 100 transits the seed to information processing device 200 via the secure communication channel, and information processing device 200 receives the seed from information processing device 100 via the secure communication channel (S501).

Then, as in the example shown in FIG. 10, information processing device 100 acquires the message (S202), and generates the digest from the message (S203).

Then, in the example shown in FIG. 13, information processing device 100 transits the digest to information processing device 200 via the secure communication channel, and information processing device 200 receives the digest from information processing device 100 via the secure communication channel (S502). In other words, at this timing, the seed is not transmitted and received.

Then, as in the example shown in FIG. 10, information processing device 200 uses the seed to generate the FTS signature from the digest (S205), and uses the seed to generate the HT signature from the public key of the FTS signature (S206). Then, information processing device 200 transmits the FTS signature and the HT signature, and information processing device 100 receives the FTS signature and the HT signature (S207). Information processing device 100 adds the combination of the FTS signature and the HT signature to the message as the signature of SPHINCS+, and outputs the signature incorporating message (S208).

In the example shown in FIG. 13, it is possible to generate the signature using the seed which is transmitted and received beforehand. Hence, it is possible to suppress the leakage of the seed.

For example, in the example shown in FIG. 1, smart meter 303 corresponds to information processing device 100 which is lower in processing speed. Control device 302 which controls the operations of smart meter 303 and home appliance 304 corresponds to information processing device 200 which is higher in processing speed. In such an environment, the information of smart meter 303 serving as a control target device may be registered in control device 302, and simultaneously, the seed may be transmitted and received. In this way, each time the signature is generated, the seed does not need to be transmitted and received. Hence, it is possible to suppress the leakage of the seed.

When information processing device 200 receives a signature generation request from a plurality of devices, information processing device 200 switches a plurality of seeds. In the example shown in FIG. 13, information processing device 200 identifies the device which requests the signature generation to switch the seeds. On the other hand, in the example shown in FIG. 10, since the seed is transmitted and received together with the digest, it is easy to switch the seeds.

The example shown in FIG. 13 corresponds to an example where the seed has been previously transmitted and received in the example shown in FIG. 10. Likewise, in the example shown in FIG. 11, the seed may be previously transmitted and received.

Although in the examples shown in FIGS. 10 to 13, information processing device 100 and information processing device 200 first establish the secure communication channel, information processing device 100 and information processing device 200 may establish the secure communication channel each time the communication is executed. When in the communication between information processing device 100 and information processing device 200, the possibility of information leakage is low, the secure communication channel does not necessarily need to be established.

When in the example shown in FIG. 12, before the secure communication channel is established, it is found that the local generation condition is satisfied, the secure communication channel does not need to be established.

Although in the example shown in FIG. 11, the generation of the HT signature and the verification of the FTS signature are executed in parallel, the generation of the HT signature and the verification of the FTS signature do not necessarily need to be executed in parallel. For example, the FTS signature and the HT signature may be collectively transmitted and received, and the FTS signature and the HT signature may be collectively verified. Depending on the processing speed of information processing device 100, there is a possibility that the FTS signature and the HT signature can be executed collectively and efficiently.

Although in the above description, the FTS signature and the HT signature are separately processed, these signatures may be collectively processed as one signature. FTS signature generator 203 and HT signature generator 204 may be regarded as one signature generator, and may be substantially integrated into one signature generator.

Although in the above description, the signature schemes which comply with SPHINCS+, FTS, and HT are used, the signature schemes which comply with them do not necessarily need to be used, and another signature scheme may be used. For example, instead of the two-stage signature of the FTS signature and the HT signature, a one-stage signature may be used, or a signature of three or more stages may be used.

A typical configuration example and a typical operation example of the electronic signature system described above will be described below.

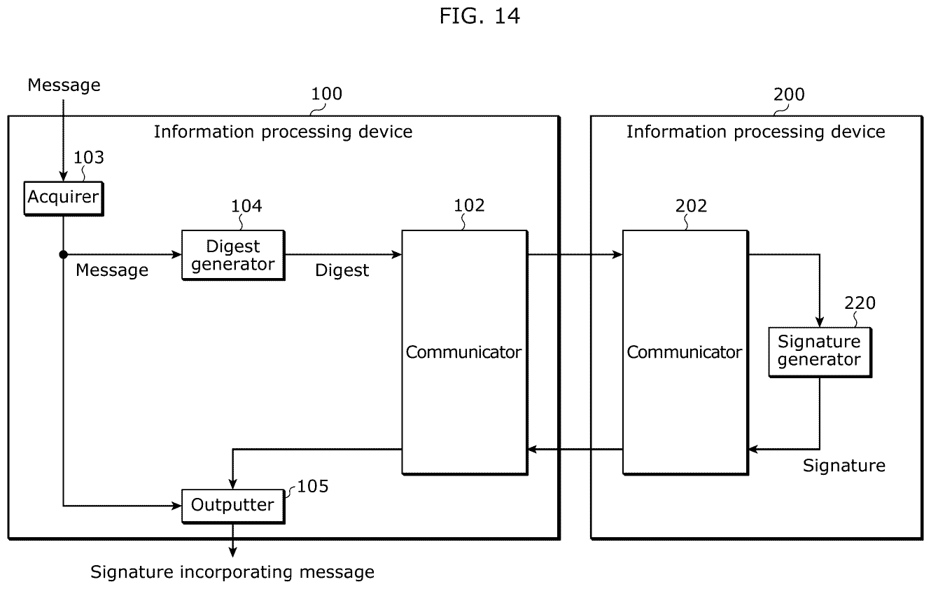

FIG. 14 is a block diagram showing the typical configuration example of the electronic signature system in the embodiment. In FIG. 14, the electronic signature system includes information processing device 100 and information processing device 200. The processing speed of information processing device 100 is lower than that of information processing device 200, and the processing speed of information processing device 200 is higher than that of information processing device 100. Information processing device 100 is also referred to as a low-speed information processing device, and information processing device 200 is also referred to as a high-speed information processing device.

Information processing device 100 includes communicator 102, acquirer 103, digest generator 104, and outputter 105. Acquirer 103 acquires the message. Digest generator 104 generates the digest from the message. Communicator 102 transmits the digest to information processing device 200, and receives the electronic signature from information processing device 200. Outputter 105 adds the electronic signature to the message, and outputs the message with the electronic signature added.

Information processing device 200 includes communicator 202 and signature generator 220. Signature generator 220 may correspond to FTS signature generator 203 and HT signature generator 204. Communicator 202 receives the digest from information processing device 100. Signature generator 220 generates the electronic signature from the digest. Communicator 202 transmits the electronic signature to information processing device 100.

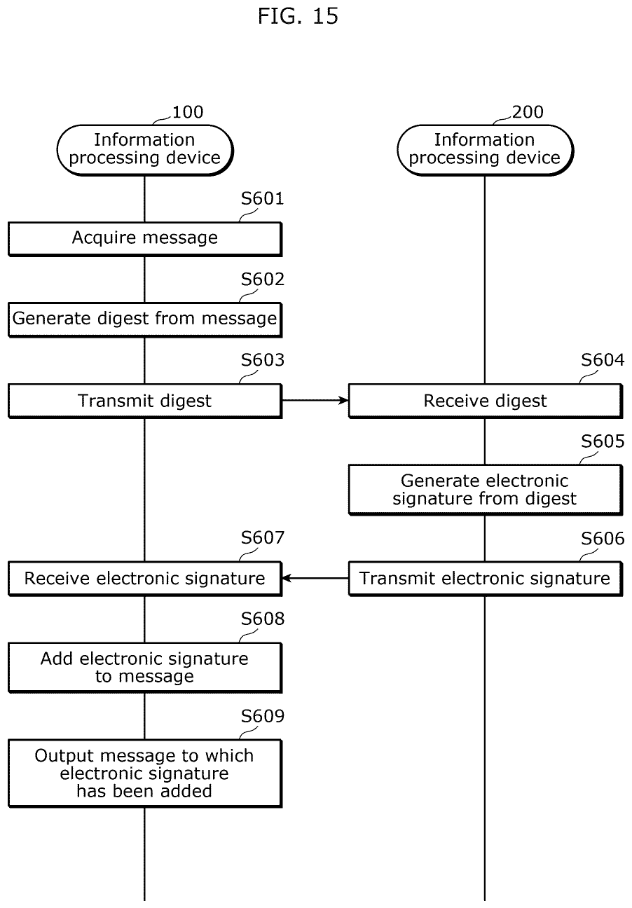

FIG. 15 is a sequence diagram showing the typical operation example of the electronic signature system in the embodiment.

Information processing device 100 acquires the message (S601). Then, information processing device 100 generates the digest from the message (S602). Then, information processing device 100 transmits the digest to information processing device 200 (S603), and information processing device 200 receives the digest from information processing device 100 (S604). Then, information processing device 200 generates the electronic signature from the digest (S605).

Then, information processing device 200 transmits the electronic signature to information processing device 100 (S606), and information processing device 100 receives the electronic signature from information processing device 200 (S607). Then, information processing device 100 adds the electronic signature to the message (S608). Then, information processing device 100 outputs the message with the electronic signature added (S609).

In this way, it is possible to generate the digest using information processing device 100 which is lower in processing speed, and to generate the electronic signature using information processing device 200 which is higher in processing speed. Hence, it is possible to suppress the transmission of the message itself. Therefore, it is possible to add the electronic signature with low delay to the message acquired by information processing device 100 which is lower in processing speed while suppressing the risk of tampering and spoofing and the amount of communication.

For example, information processing device 100 may transmit, to information processing device 200, the parameter corresponding to the private key for generating the electronic signature. Information processing device 200 may receive the parameter from information processing device 100. Then, information processing device 200 may use the parameter to generate the electronic signature from the digest.

In this way, it is possible to utilize, for the generation of the electronic signature, the parameter transmitted from first information processing device 100 and received by second information processing device 200. Hence, instead of information processing device 100, in information processing device 200, it is possible to correctly generate the electronic signature. The parameter corresponding to the private key for generating the electronic signature may be the parameter for generating the private key such as the seed described above, or may be the private key itself.

For example, information processing device 100 may transmit the parameter to information processing device 200 together with the digest. Then, information processing device 200 may receive the parameter from information processing device 100 together with the digest. In this way, it is possible to smoothly generate the electronic signature from the digest using the parameter which is transmitted and received together with the digest.

For example, information processing device 100 may transmit, before transmitting the digest, the parameter to information processing device 200 separately from the digest. Then, second information processing device 200 may receive, before receiving the digest, the parameter from information processing device 100 separately from the digest. In this way, it is possible to generate the electronic signature from the digest using the parameter which is transmitted and received beforehand. Hence, it is possible to suppress the leakage of the parameter corresponding to the private key.

For example, information processing device 100 may verify the electronic signature after receiving the electronic signature from information processing device 200. Information processing device 100 may add the electronic signature to the message upon successful verification of the electronic signature. In this way, it is possible to add the electronic signature to the message after confirming the authenticity of the electronic signature. Hence, it is possible to further suppress the risk of tampering, spoofing, and the like.

For example, the electronic signature may include the first electronic signature and the second electronic signature. Information processing device 200 may generate the first electronic signature from the digest. Information processing device 200 may generate the second electronic signature from the public key of the first electronic signature. Thereafter, information processing device 200 may transmit the first electronic signature and the second electronic signature to information processing device 100.

Then, information processing device 100 may receive the first electronic signature and the second electronic signature from information processing device 200. Thereafter, information processing device 100 may add the first electronic signature and the second electronic signature to the message. Then, information processing device 100 may output the message with the first electronic signature and the second electronic signature added.

In this way, it is possible to generate the two electronic signatures using information processing device 200 which is higher in processing speed. Hence, it is possible to suppress a processing delay as compared with a case where information processing device 100 which is lower in processing speed generates the two electronic signatures.

For example, information processing device 200 may transmit the first electronic signature to information processing device 100 after generating the first electronic signature and before generating the second electronic signature. Information processing device 200 may transmit the second electronic signature to information processing device 100 after generating the second electronic signature.

Information processing device 100 may start to verify the first electronic signature after receiving the first electronic signature and before receiving the second electronic signature. Information processing device 100 may start to verify the second electronic signature after receiving the second electronic signature. Thereafter, information processing device 100 may add the first electronic signature and the second electronic signature to the message upon successful verification of the first electronic signature and the second electronic signature.

In this way, it is possible to add the first electronic signature and the second electronic signature to the message after confirming the authenticity of the first electronic signature and the second electronic signature. Hence, it is possible to further suppress the risk of tampering, spoofing, and the like. It is also possible to start to verify the first electronic signature at an early stage. Therefore, it is possible to suppress a processing delay.

For example, the electronic signature may comply with SPHINCS+. The first electronic signature may comply with few-times signature (FTS). The second electronic signature may comply with hypertree (HT). In this way, it is possible to add the highly reliable electronic signatures to the messages according to SPHINCS+, FTS and HT.

For example, information processing device 200 may generate the electronic signature in the protected region where storage and transmission are performed in an encrypted state. In this way, in information processing device 200, it is possible to further suppress the risk of tampering and spoofing.

For example, when the condition for generating the electronic signature in information processing device 100 is satisfied, information processing device 100 may generate the electronic signature from the digest without transmitting the digest to information processing device 200.

In this way, it is possible to adaptively generate the electronic signature in information processing device 100 or information processing device 200 according to the condition. Hence, it is possible to efficiently distribute the processing.

A part or all of the configuration examples and the operation examples described with reference to FIGS. 1 to 13 may be added to the typical configuration example and the typical operation example described with reference to FIGS. 14 and 15, and a change may be made according to the part or all thereof.

A plurality of constituent elements in information processing device 100 may be formed with a processor. Specifically, a plurality of constituent elements other than memory 101 in information processing device 100 may be formed with a processor. Then, the processor may play the roles of the constituent elements. Likewise, a plurality of constituent elements in information processing device 200 may be formed with a processor. Specifically, a plurality of constituent elements other than memory 201 in information processing device 200 may be formed with a processor. Then, the processor may play the roles of the constituent elements.

Although the aspects of the electronic signature system and the information processing device have been described above according to the embodiment, the aspects of the electronic signature system and the information processing device are not limited to the embodiment. Variations conceived by those skilled in the art may be performed on the embodiment, and a plurality of constituent elements in the embodiment may be arbitrarily combined.

For example, processing which is executed by a specific constituent element in the embodiment may be executed by another constituent element instead of the specific constituent element. The order of a plurality of processing steps may be changed, and a plurality of processing steps may be executed in parallel. The ordinal numbers such as first and second used in the description may be changed, removed, or newly added as necessary. These ordinal numbers do not necessarily correspond to a meaningful order, and may be used to identify elements.

An electronic signature method or an information processing method which include steps executed by constituent elements in the electronic signature system or the information processing device may be executed by an arbitrary system or device. In other words, the electronic signature method or the information processing method may be executed by the electronic signature system or the information processing device described above, or may be executed by another system or device.

For example, a part or all of the electronic signature method or the information processing method may be executed by a computer system which includes a processor, a memory, an input/output circuit, and the like. At that time, a program for causing the computer system to execute the electronic signature method or the information processing method may be executed by the computer system, and thus the electronic signature method or the information processing method may be executed.

For example, the program described above causes a computer system corresponding to the information processing device to execute the information processing method that is executed by the information processing device and includes: acquiring a message; generating a digest from the message; transmitting the digest to a high-speed information processing device that is higher in processing speed than the information processing device; receiving an electronic signature from the high-speed information processing device; adding the electronic signature to the message; and outputting the message with the electronic signature added.

For example, the program described above causes a computer system corresponding to the information processing device to execute the information processing method that is executed by the information processing device and includes: receiving a digest from a low-speed information processing device that is lower in processing speed than the information processing device; generating an electronic signature from the digest; and transmitting the electronic signature to the low-speed information processing device.

The program described above may be recorded in a non-transitory computer-readable recording medium such as a CD-ROM.

The constituent elements of the electronic signature system or the information processing device may be formed by dedicated hardware, may be formed by general-purpose hardware which executes the program described above and the like, or may be formed by a combination thereof. The general-purpose hardware may be formed with a memory in which the program is recorded, a general-purpose processor which reads the program from the memory, and the like. Here, the memory may be a semiconductor memory, a hard disk, or the like, and the general-purpose processor may be a CPU or the like.

The dedicated hardware may be formed with a memory, a dedicated processor, and the like. For example, the dedicated processor may reference the memory to execute the electronic signature method or the information processing method.

The constituent elements of the information processing device may be electrical circuits. These electrical circuits may form one electrical circuit as a whole, or may be separate electrical circuits. These electrical circuits may correspond to the dedicated hardware, or may correspond to the general-purpose hardware which executes the program described above and the like.

### INDUSTRIAL APPLICABILITY

The present disclosure can be utilized for an electronic signature system and the like which add an electronic signature to a message, and can be applied to a communication system and the like.

1. An electronic signature system comprising:
a first information processing device; and
a second information processing device that is higher in processing speed than the first information processing device,
wherein the first information processing device:
acquires a message;
generates a digest from the message; and
transmits the digest to the second information processing device,
the second information processing device:
receives the digest from the first information processing device;
generates an electronic signature from the digest; and
transmits the electronic signature to the first information processing device, and
the first information processing device:
receives the electronic signature from the second information processing device;
adds the electronic signature to the message; and
outputs the message with the electronic signature added.

2. The electronic signature system according to claim 1,
wherein the first information processing device transmits, to the second information processing device, a parameter corresponding to a private key for generating the electronic signature, and
the second information processing device:
receives the parameter from the first information processing device; and
uses the parameter to generate the electronic signature from the digest.

3. The electronic signature system according to claim 2,
wherein the first information processing device transmits the parameter to the second information processing device together with the digest, and
the second information processing device receives the parameter from the first information processing device together with the digest.

4. The electronic signature system according to claim 2,
wherein the first information processing device transmits, before transmitting the digest, the parameter to the second information processing device separately from the digest, and
the second information processing device receives, before receiving the digest, the parameter from the first information processing device separately from the digest.

5. The electronic signature system according to claim 1,
wherein the first information processing device:
verifies the electronic signature after receiving the electronic signature from the second information processing device, and
adds the electronic signature to the message upon successful verification of the electronic signature.

6. The electronic signature system according to claim 1,
wherein the electronic signature includes a first electronic signature and a second electronic signature,
the second information processing device:
generates the first electronic signature from the digest;
generates the second electronic signature from a public key of the first electronic signature; and
transmits the first electronic signature and the second electronic signature to the first information processing device, and
the first information processing device:
receives the first electronic signature and the second electronic signature from the second information processing device;
adds the first electronic signature and the second electronic signature to the message; and
outputs the message with the first electronic signature and the second electronic signature added.

7. The electronic signature system according to claim 6,
wherein the second information processing device:
transmits the first electronic signature to the first information processing device after generating the first electronic signature and before generating the second electronic signature; and
transmits the second electronic signature to the first information processing device after generating the second electronic signature, and
the first information processing device:
starts to verify the first electronic signature after receiving the first electronic signature and before receiving the second electronic signature;
starts to verify the second electronic signature after receiving the second electronic signature; and
adds the first electronic signature and the second electronic signature to the message upon successful verification of the first electronic signature and the second electronic signature.

8. The electronic signature system according to claim 6,
wherein the electronic signature complies with SPHINCS+,
the first electronic signature complies with few-times signature (FTS), and
the second electronic signature complies with hypertree (HT).

9. The electronic signature system according to claim 1,
wherein the second information processing device generates the electronic signature in a protected region where storage and transmission are performed in an encrypted state.

10. The electronic signature system according to claim 1,
wherein when a condition for generating the electronic signature in the first information processing device is satisfied, the first information processing device generates the electronic signature from the digest without transmitting the digest to the second information processing device.

11. An information processing device comprising:
an acquirer that acquires a message;
a digest generator that generates a digest from the message;
a communicator that:
transmits the digest to a high-speed information processing device that is higher in processing speed than the information processing device; and
receives an electronic signature from the high-speed information processing device; and
an outputter that adds the electronic signature to the message, and outputs the message with the electronic signature added.

12. An information processing device comprising:
a communicator that receives a digest from a low-speed information processing device that is lower in processing speed than the information processing device; and
a signature generator that generates an electronic signature from the digest,
wherein the communicator transmits the electronic signature to the low-speed information processing device.

13. An information processing method executed by an information processing device, the information processing method comprising:
acquiring a message;
generating a digest from the message;
transmitting the digest to a high-speed information processing device that is higher in processing speed than the information processing device;
receiving an electronic signature from the high-speed information processing device;
adding the electronic signature to the message; and
outputting the message with the electronic signature added.

14. An information processing method executed by an information processing device, the information processing method comprising:
receiving a digest from a low-speed information processing device that is lower in processing speed than the information processing device;
generating an electronic signature from the digest; and
transmitting the electronic signature to the low-speed information processing device.

15. A non-transitory computer-readable recording medium having recorded thereon a program for causing the information processing device to execute the information processing method according to claim 13.

16. A non-transitory computer-readable recording medium having recorded thereon a program for causing the information processing device to execute the information processing method according to claim 14.
